(19) United States
(12) Patent Application Publication
(10) Pub. No.: US 2026/0052214 A1
(43) Pub. Date: Feb. 19, 2026

(54) INSPECTION APPARATUS

(71) Applicant: CANON KABUSHIKI KAISHA, Tokyo (JP)

(72) Inventor: TAKESHI KINOSHITA, Chiba (JP)

(21) Appl. No.: 19/291,735

(22) Filed: Aug. 6, 2025

(30) Foreign Application Priority Data
Aug. 13, 2024 (JP) 2024-135034

(51) Int. Cl. H04N 1/00

(52) U.S. Cl. CPC H04N 1/00005; H04N 1/00015; H04N 1/00076; H04N 1/00087; H04N 1/00411; H04N 1/00469

(57) ABSTRACT

An inspection apparatus includes an inspection unit configured to perform inspection on an inspection image obtained by reading a sheet on which an image is formed, based on a reference image and the inspection image. The inspection apparatus further includes a display unit, and a display control unit configured to display, on the display unit, a setting screen including a first display area that displays the reference image and a second display area that displays an operation object for accepting an inspection setting for the inspection. The display control unit determines an arrangement of the first display area and the second display area in the setting screen in accordance with a size of the reference image.

### BACKGROUND

### Field of the Technology

The present disclosure relates to an inspection apparatus that inspects the quality of an image formed on a sheet.

### Description of the Related Art

In some image forming systems, an inspection apparatus inspects the quality of an image formed on a sheet by an image forming apparatus. The inspection apparatus performs inspection based on a read image (inspection image) obtained by reading an image formed on a sheet. For example, the image forming system accepts inspection settings via an inspection setting screen displayed on a display device, and when inspection performed according to the inspection settings is complete, the inspection apparatus displays results of the inspection on the display device to present the inspection results to the user.

Japanese Patent Laid-Open No. 2023-105790 describes an inspection setting screen layout in which an image to be printed (a reference image that serves as the basis for the inspection) is arranged on the right side of the screen, and a group of buttons for setting the inspection area and a group of menus are arranged on the left side of the screen. With such an inspection setting screen, a user can easily set the inspection area to be inspected, based on the display of the image to be printed.

In recent years, in addition to standard size sheets such as A4 and B5, various types of sheets such as long-sized sheets (long paper), which are long in the conveying direction, and free size sheets have become the subject of inspection by an inspection apparatus. For example, when inspection is to be performed on a long-sized sheet, if the display direction of the reference image displayed on the inspection setting screen is not determined appropriately, the reference image may be displayed in a small size on the screen. This may make it difficult for the user to appropriately set the content of the inspection while viewing the reference image in the inspection setting screen.

### SUMMARY

The present disclosure provides a technique for controlling the display of a setting screen so as to make it easier for inspection settings to be set by a user.

According to one aspect of the present disclosure, there is provided an inspection apparatus comprising: an inspection unit configured to perform inspection on an inspection image obtained by reading a sheet on which an image is formed, based on a reference image and the inspection image; a display unit; and a display control unit configured to display, on the display unit, a setting screen including a first display area that displays the reference image and a second display area that displays an operation object for accepting an inspection setting for the inspection, wherein the display control unit determines an arrangement of the first display area and the second display area in the setting screen in accordance with a size of the reference image.

According to another aspect of the present disclosure, there is provided an inspection apparatus comprising: an inspection unit configured to perform inspection on an inspection image obtained by reading a sheet on which an image is formed; a display unit; and a display control unit configured to, in a case where an abnormal image is included in an inspection result, display, on the display unit, an inspection result confirmation screen including a first display area that displays the inspection image and a second display area that displays an enlarged image obtained by enlarging the abnormal image in the inspection image, wherein the display control unit determines an arrangement of the first display area and the second display area in the confirmation screen in accordance with a size of the inspection image.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a cross-sectional view showing an example of the hardware configuration of an image forming system.

FIG. 2 is a block diagram showing an example of the configuration of a control apparatus.

FIG. 3 is a block diagram showing an example of the configuration of an inspection apparatus.

FIG. 4 is a block diagram showing an example of the configuration of a stacking apparatus.

FIG. 5 is a flowchart showing an example of a processing procedure performed by the control apparatus.

FIG. 6 is a flowchart showing an example of a processing procedure performed by the inspection apparatus.

FIG. 7 shows an example of a print setting screen.

FIG. 8 shows an example of an inspection setting screen.

FIGS. 9A and 9B show examples of layouts of the inspection setting screen.

FIGS. 10A and 10B show examples of layouts of the inspection setting screen.

FIGS. 11A and 11B are flowcharts showing examples of a procedure of processing for determining the display direction of a reference image.

FIGS. 12A and 12B show examples of the inspection setting screen and a layout setting screen.

FIGS. 13A and 13B show examples of an inspection result screen.

FIG. 14 shows an example of the inspection setting screen (comparative example).

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### <Image Forming System>

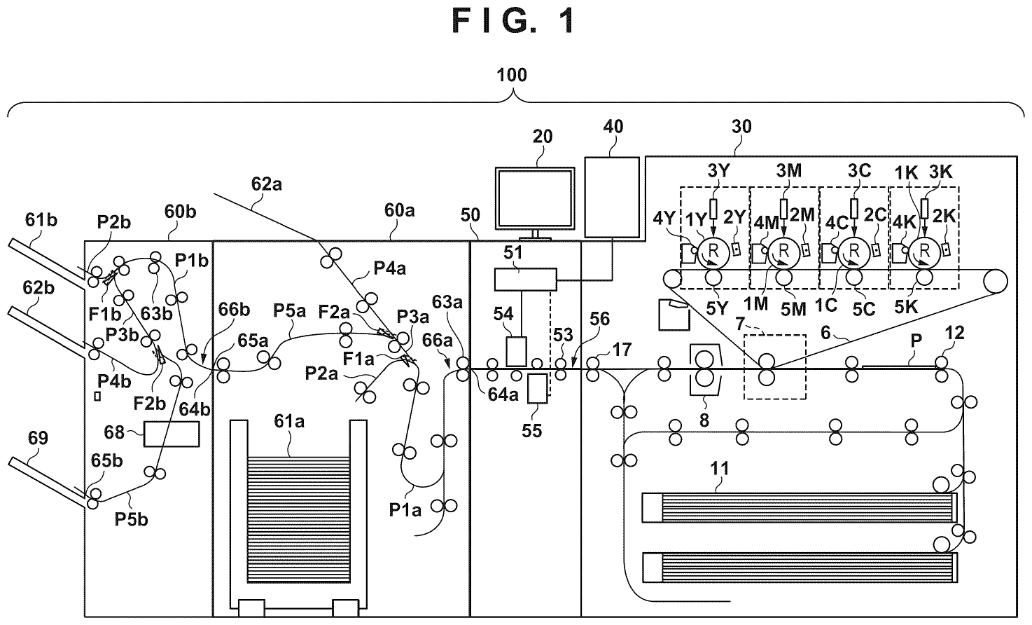

As shown in FIG. 1, an image forming system 100 includes an operation unit 20, an image forming apparatus 30, a control apparatus 40, an inspection apparatus 50, and stacking apparatuses 60a and 60b. The image forming apparatus 30, the inspection apparatus 50, and the stacking apparatuses 60a and 60b each have a separate housing. The number of stacking apparatuses 60 may be one or more. The image forming system 100 may also be referred to as an image inspection system. In this example, the stacking apparatus 60a may be called a sheet stacker or a sheet conveying apparatus. The stacking apparatus 60b may be called a post-processing apparatus having a post-processing function, or a finisher. Identical or similar components are denoted by the same reference numbers, and the final lowercase letter (e.g., “a” or “b”) may be omitted when describing matters common to these components.

The operation unit 20 has a display device for outputting information to the user, and an input device (e.g., a touch panel sensor) for receiving instructions from the user.

The image forming apparatus 30 forms a toner image on a sheet P in accordance with YMCK color signals supplied by the control apparatus 40. The letters “YMCK” appended to the reference signs represent the toner colors yellow, magenta, cyan, and black, respectively. The letters YMCK will be omitted from the reference numbers when describing matter common to all four colors.

For each of the colors, a photosensitive member 1 is an image carrier that carries an electrostatic latent image and a toner image. A charger 2 charges the surface of the photosensitive member 1 uniformly. An exposure unit 3 forms an electrostatic latent image on the photosensitive member 1 by irradiating it with laser light that conforms to a color signal supplied by the control apparatus 40. A developing unit 4 develops the electrostatic latent image with toner to form a toner image. A primary transfer roller 5 transfers the toner image from the photosensitive member 1 to an intermediate transfer belt 6. YMCK toner images are superimposed on the intermediate transfer belt 6 to form a color image. The intermediate transfer belt 6 transports the resulting toner image to a secondary transfer unit 7.

Sheet cassettes 11 are containers for storing large numbers of sheets P. Conveying rollers 12 feed the sheets P stored in the sheet cassettes 11 and convey the fed sheets P along a conveying path. The image forming apparatus 30 may have two or more sheet cassettes.

The secondary transfer unit 7 transfers the toner image from the intermediate transfer belt 6 to a sheet P. A fuser 8 applies heat and pressure to the sheet P and the toner image to fuse the toner image onto the sheet P. Discharge rollers 17 discharge the sheet P to the inspection apparatus 50.

The inspection apparatus 50 is an apparatus that reads the image formed on the sheet P and inspects the quality of the image. In other words, the inspection apparatus 50 is an apparatus that inspects whether or not the image formed on the sheet P meets an inspection standard (acceptance standard). Note that the sheet P on which the image is formed is sometimes called a printed material. The inspection apparatus 50 obtains an inspection image by reading the printed material, which includes the sheet P and the image formed on the sheet P by the image forming apparatus 30, and performs inspection on the printed material based on the inspection image.

The image on the sheet P being conveyed to a reading position by conveying rollers 53 is read by image sensors 54 and 55. The image sensors 54 and 55 each include a light source that illuminates the sheet P and a CMOS sensor. CMOS is an abbreviation for Complementary Metal-Oxide Semiconductor.

The sheet P from which the image has been read is discharged to the stacking apparatus 60a. Note that when the inspection apparatus 50 determines that a sheet P has failed the inspection (i.e., the inspection standard has not been met, which will also be called “unacceptable”), the control apparatus 40 may control the image forming apparatus 30 so as to form the same image on a new sheet P. A sheet sensor 56 for detecting the sheet P is provided at the entrance of the inspection apparatus 50.

The stacking apparatus 60a receives sheets P discharged from the inspection apparatus 50 at an entrance 64a, stacks (discharges) the sheets onto a sheet tray 61a or a sheet tray 62a serving as stacking units, and discharges the sheet P from an exit 65a. A sheet sensor 66a for detecting a sheet P is provided at the entrance 64a.

A conveying path P1a extending from the entrance 64a branches into a conveying path P2a and a conveying path P3a at a branching position where a flapper F1a is provided. A sheet P conveyed along the conveying path P1a is guided by the flapper F1a to the conveying path P2a or the conveying path P3a. The sheet tray 61a is provided at the exit of the conveying path P2a. The sheet tray 61a is a large-capacity sheet stacking unit in which a large number of sheets P can be stacked. For example, sheets P that have been determined to have passed image inspection (quality inspection) may be stacked in the sheet tray 61a.

The conveying path P3a branches into a conveying path P4a and a conveying path P5a at a branching position where a flapper F2a is provided. A sheet P conveyed along the conveying path P3a is guided by the flapper F2a to the conveying path P4a or the conveying path P5a.

The sheet tray 62a is provided at the exit of the conveying path P4a. For example, sheets P for which the image quality has been determined to be unacceptable by the inspection apparatus 50 may be stacked in the sheet tray 62a. However, sheets P for which the image quality has been determined to be unacceptable may be discharged from the exit 65a to a downstream device (e.g., the stacking apparatus 60c). Also, sheets P determined to have passed the inspection (i.e., the inspection standard has been met, which will also be called “acceptable”) may be stacked in the sheet tray 62a. The conveying path P5a extends to the exit 65a.

The downstream stacking apparatus 60b may be connected to the exit 65a. Also, similarly to the stacking apparatus 60b, a sheet tray 69 may be provided at the exit 65a. The sheet tray 69 can also hold sheets P for which the image quality has been determined to be unacceptable or sheets P for which the image quality has been determined to be acceptable. In this way, the type of sheets P that are to be discharged onto the sheet trays 61a, 61b, 62a, 62b, and 69 is determined in advance based on setting performed by the user.

One or more conveying rollers 63a are provided for each of the conveying paths P1a, P2a, P3a, P4a, and P5a. The conveying rollers 63a convey a sheet P from the upstream side to the downstream side in the conveying direction of the sheet P. The conveying rollers 63a may be a roller pair including two rollers that nip and convey the sheet P.

The stacking apparatus 60b receives sheets P discharged from the stacking apparatus 60a at an entrance 64b, and stacks (discharges) the sheets onto sheet trays 61b, 62b, and 69 serving as stacking units. A sheet sensor 66b for detecting a sheet P is provided at the entrance 64b.

A conveying path P1b extending from the entrance 64b branches into a conveying path P2b and a conveying path P3b at a branching position where a flapper F1b is provided. A sheet P conveyed along the conveying path P1b is guided by the flapper F1b to the conveying path P2b or the conveying path P3b. The sheet tray 61b is provided at the exit of the conveying path P2b. For example, sheets P that have been determined to have passed image inspection (quality inspection) may be stacked in the sheet tray 61b.

The conveying path P3b branches into a conveying path P4b and a conveying path P5b at a branching position where a flapper F2b is provided. A sheet P conveyed along the conveying path P3b is guided by the flapper F2b to the conveying path P4b or the conveying path P5b.

The sheet tray 62b is provided at the exit of the conveying path P4b. For example, sheets P for which the image quality has been determined to be unacceptable by the inspection apparatus 50 may be stacked in the sheet tray 62b. However, sheets P for which the image quality has been determined to be unacceptable may be discharged from the exit 65b to the sheet tray 69. Also, sheets P determined to have passed the inspection (i.e., the inspection standard has been met, which will also be called “acceptable”) may be stacked in the sheet tray 62b. The conveying path P5b extends through a post-processing unit 68 and reaches the exit 65b.

The sheet trays 61b, 62b, and 69 provided in the stacking apparatus 60b may be referred to as an upper tray, a middle tray, and a lower tray, respectively. The post-processing unit 68 may include a binding processor that binds the sheets P discharged from the stacking apparatus 60a to create a sheet bundle, and then binds the sheet bundle with staples. The post-processing unit 68 may include a bookbinding processor that folds the sheet bundle in half. The post-processing unit 68 may include a cutting processor that cuts the sheet bundle.

One or more conveying rollers 63b are provided for each of the conveying paths P1b, P2b, P3b, P4b, and P5b. The conveying rollers 63b convey a sheet P from the upstream side to the downstream side in the conveying direction of the sheet P. The conveying rollers 63b may be a roller pair including two rollers that nip and convey the sheet P.

The number of stacking apparatuses 60 connected downstream of the inspection apparatus 50 may be one or more. Furthermore, the total number of sheet trays 61, 62, and 69 provided in a stacking apparatus 60 connected downstream of the inspection apparatus 50 may be two or more. Moreover, the number of flappers F1 and F2 may be one or more. The flappers F1 and F2 may be called guide plates, guide members, or bifurcating claws. Note that the image forming apparatus 30 also includes solenoids for driving the flappers and motors for driving the conveying rollers, but these components are not shown.

### <Control Apparatus (Controller)>

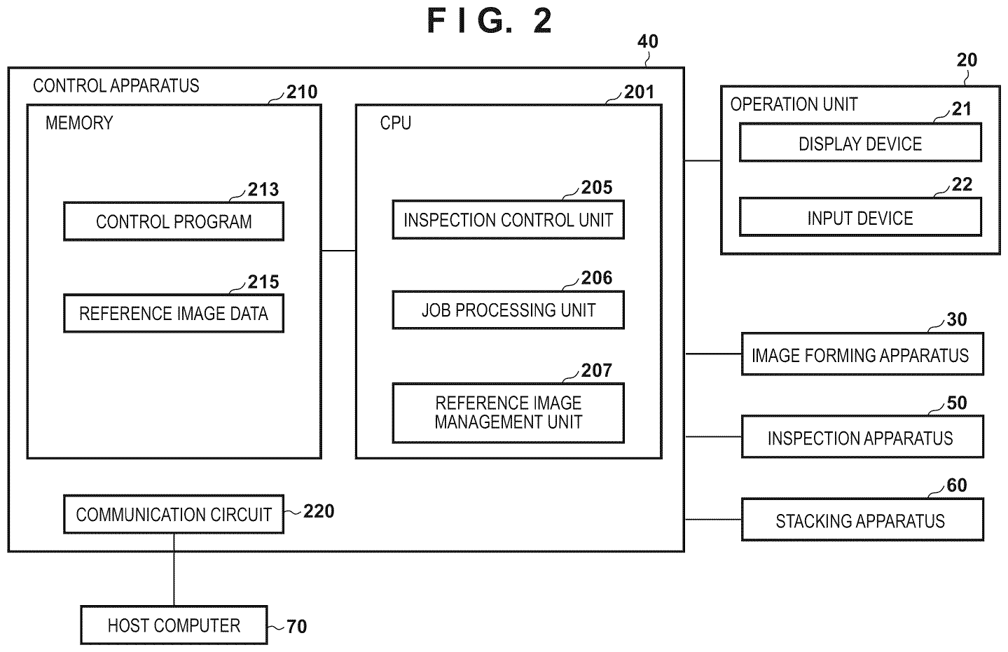

FIG. 2 shows an example of the configuration of the control apparatus 40. The control apparatus 40 includes a CPU 201, a memory 210, and a communication circuit 220. The CPU 201 executes a control program 213 stored in the memory 210 to realize various functions. The CPU 201 may include multiple processors or CPU cores. Some or all of the functions implemented by the CPU 201 may be implemented by a hardware circuit different from the CPU 201. Examples of such hardware circuits include, for example, application specific integrated circuits (ASICs), field programmable gate arrays (FPGAs), and image processors.

The memory 210 is a storage device that includes a read-only memory (ROM), a random access memory (RAM), a solid-state drive (SSD), a hard disk drive (HDD), or the like. The communication circuit 220 has a network interface for connecting to a local area network, and a communication interface for communicating with the image forming apparatus 30, the inspection apparatus 50, and the stacking apparatus 60.

The CPU 201 performs communication with the image forming apparatus 30, the inspection apparatus 50, and the stacking apparatus 60 through the communication circuit 220. Furthermore, the CPU 201 performs communication with a host computer 70, which is a type of information processing device, through the communication circuit 220. The host computer 70 may transmit print jobs to the control apparatus 40.

The operation unit 20 includes the display device 21 and the input device 22. The operation unit 20 may include a voice circuit and a speaker for outputting messages to the user.

The CPU 201 functions as an inspection control unit 205, a job processing unit 206, and a reference image management unit 207 in accordance with the control program 213. The inspection control unit 205 obtains image inspection result information (e.g., pass/fail, read image, cause of failure) from the inspection apparatus 50 via the communication circuit 220. The inspection control unit 205 displays the inspection result received from the inspection apparatus 50 on the display device 21. The inspection control unit 205 may notify the inspection result using a voice message. The inspection control unit 205 may transmit the inspection result to the host computer 70 by email or the like. The inspection control unit 205 may change the discharge destination of a sheet P in accordance with the inspection result. For example, the inspection control unit 205 may control the flappers F1 and F2 based on the inspection result to discharge a sheet P to a sheet tray designated by the user from among the sheet trays 61, 62, and 69.

The job processing unit 206 performs control regarding, for example, a print job for printing an image on a sheet P, a stacking job for stacking a sheet bundle on the stacking apparatus 60a, and a post-processing job for a sheet bundle in the stacking apparatus 60b. The job processing unit 206 may store job data (job information) required to execute such jobs in the memory 210.

The reference image management unit 207 controls the inspection apparatus 50 in accordance with instructions received from the input device 22, and generates reference image data 215. Here, the reference image is an image that is compared with a read image (inspection image) of a printed material, and serves as a reference for determining whether image inspection has been passed. The reference image management unit 207 generates the reference image data 215 based on, for example, input image data received from the host computer 70, or reads a printed material (a sheet P on which a reference image is printed) to generate the reference image data 215. The reference image management unit 207 stores the generated reference image data 215 in the memory 210. Upon receiving a reference image request from the inspection apparatus 50 via the communication circuit 220, the reference image management unit 207 transmits the reference image data 215 from the memory 210 to the inspection apparatus 50.

### <Inspection Apparatus>

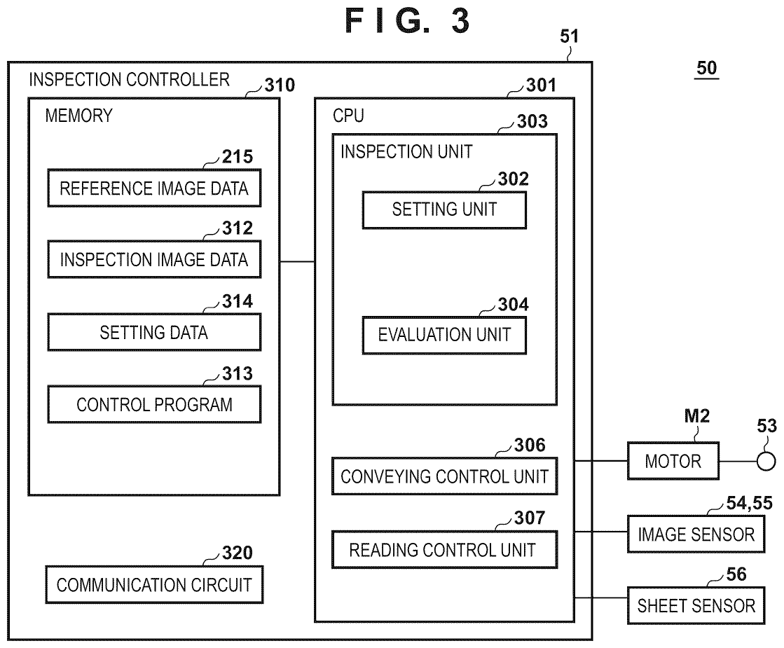

FIG. 3 shows an example of the configuration of the inspection apparatus 50, which includes an inspection controller 51. The inspection controller 51 includes a CPU 301, a memory 310, and a communication circuit 320. The CPU 301 executes a control program 313 stored in the memory 310 to realize various functions. Some or all of the functions implemented by the CPU 301 may be implemented by a hardware circuit different from the CPU 301.

The memory 310 is a storage device that includes a ROM, a RAM, an SSD, an HDD, or the like. The CPU 301 is connected to the control apparatus 40 via a communication circuit 320, and receives various types of commands and data and transmits inspection results. The CPU 301 stores the reference image data 215 received from the control apparatus 40 via the communication circuit 320 in the memory 310.

The CPU 301 functions as an inspection unit 302, a conveying control unit 306, and a reading control unit 307 in accordance with the control program 313. The inspection unit 302 includes a setting unit 303 and an evaluation unit 304. The inspection unit 302 executes image inspection in accordance with setting data 314 stored in the memory 310, and transmits inspection results to the control apparatus 40. Note that inspection may be executed by the CPU 201 or may be executed by an external PC (e.g., the host computer 70) connected to the image forming system 100. PC is an abbreviation for personal computer.

Inspection image data (read image data) 312 is image data created by the image sensors 54 and 55 reading a sheet P. The inspection image data 312 is also temporarily stored in the memory 310.

The setting unit 303 determines inspection settings to be applied to the inspection image data 312, creates the setting data 314 that defines the inspection settings, and stores the setting data 314 in the memory 310.

The evaluation unit 304 determines whether the leading edge of a sheet P has reached the inspection apparatus 50 based on the detection result of the sheet sensor 56. When a sheet P reaches the inspection apparatus 50, the evaluation unit 304 controls the image sensors 54 and 55 via the reading control unit 307 to read the sheet P and obtain the inspection image data 312. The evaluation unit 304 compares the reference image data 215 with the inspection image data 312 based on the setting data 314, and determines whether the image formed on the sheet P and the shape of the sheet P meet the inspection standard. Here, the inspection content, the inspection area, and the inspection standard may be included in the setting data 314.

For example, when the inspection content is “detection of positional deviation”, the evaluation unit 304 may determine that the inspection has been passed if the amount of deviation between the position of the image corresponding to the reference image data 215 and the position of the image corresponding to the inspection image data 312 is less than or equal to a predetermined value. Here, the position of the image refers to the position of the image formed on the sheet P. If the amount of deviation exceeds the predetermined value, the evaluation unit 304 may determine that the sheet P failed the inspection. In other words, if the amount of deviation between the position of the image corresponding to the reference image data 215 and the position of the image corresponding to the inspection image data 312 is less than or equal to the predetermined value, this corresponds to meeting the inspection standard. If the amount of deviation between the position of the image corresponding to the reference image data 215 and the position of the image corresponding to the inspection image data 312 that is greater than the predetermined value, this corresponds to not meeting the inspection standard.

When the inspection content is set to “black spot detection”, the evaluation unit 304 may determine that the inspection has been passed if the size of a black spot that is not present in the image corresponding to the reference image data 215 and is present in the image of the inspection image data 312 is smaller than or equal to a determination threshold. In other words, the black dot corresponds to a noise image that is not present in the image corresponding to the reference image data 215 but is present in the image corresponding to the inspection image data 312 that has been subjected to reduction processing. The evaluation unit 304 may determine that the inspection has not been passed if the size of the black dot exceeds the determination threshold. In other words, if the size of the black dot does not exceed the determination threshold, this corresponds to meeting the inspection standard. Moreover, if the size of the black dot exceeds the determination threshold, this corresponds to not meeting the inspection standard.

Note that in the present embodiment, “detection of positional deviation” and “black spot detection” are described as inspection content, but these are merely examples. For example, the inspection content may include “streak detection” and the like. Streak detection refers to the detection of streak-like images that are not present in the original image. In other words, a streak corresponds to a noise image that is not present in the image corresponding to the reference image data 215 but is present in the image corresponding to the inspection image data 312 that has been subjected to reduction processing. Streaks can occur when parts involved in image formation require cleaning, replacement, or repair. In other words, determination processing may be performed to determine the presence or absence of streaks based on the degree of agreement between the image corresponding to the reference image data 215 and the image corresponding to the inspection image data 312 that has been subjected to reduction processing (image processing).

In the present embodiment, when the inspection content is “detection of positional deviation”, inspection is performed regarding the relative positions of the image corresponding to the reference image data 215 and the image corresponding to the inspection image data 312, but this is merely one example. For example, the absolute position of an edge of the sheet P in the image corresponding to the inspection image data 312 may be inspected. In this case, if the distance between the absolute position of the image corresponding to the reference image data 215 and the absolute position of the image corresponding to the inspection image data 312 is less than or equal to a threshold value, it is determined that the inspection has been passed. If the distance exceeds the threshold, it is determined that the inspection has been failed.

The evaluation unit 304 creates an inspection result indicating the determination result. The evaluation unit 304 transmits the inspection results to the control apparatus 40 via the communication circuit 320. In this way, the inspection unit 302 obtains the reference image data 215, which serves as the standard for inspecting a printed material, from the control apparatus 40, and obtains the inspection image data 312 by reading the printed material, which includes a sheet transported from the image forming apparatus 30 and an image formed on the sheet. The inspection unit 302 performs inspection on the printed material based on the reference image data 215 and the inspection image data 312.

The conveying control unit 306 drives a motor M2 to rotate the conveying rollers 53. The reading control unit 307 controls the image sensors 54 and 55 to read the sheet P and generate the inspection image data 312. The image sensor 54 reads a first side of the sheet P, and image sensor 55 reads a second side of the sheet P. As a result, in the present embodiment, image inspection can be executed on both sides of the sheet P.

### <Stacking Apparatus>

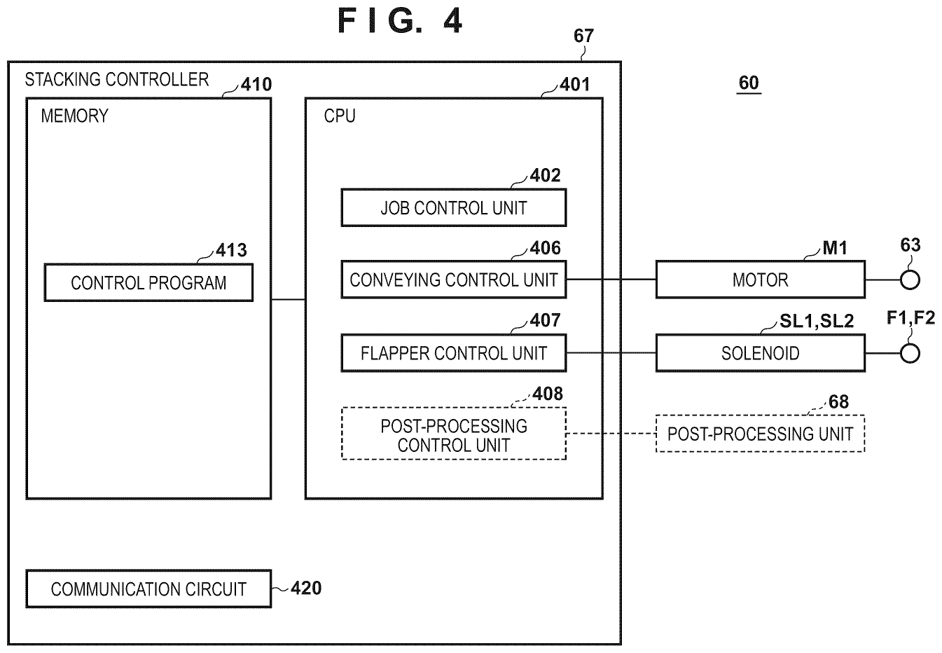

FIG. 4 shows an example of the configuration of one stacking apparatus 60, which includes a stacking controller 67. The stacking controller 67 includes a CPU 401, a memory 410, and a communication circuit 420. The CPU 401 executes a control program 413 stored in the memory 410 to realize various functions. Some or all of the functions implemented by the CPU 401 may be implemented by a hardware circuit different from the CPU 401.

The memory 410 is a storage device that includes a ROM, a RAM, an SSD, an HDD, or the like. The CPU 401 is connected to the control apparatus 40 via the communication circuit 420, and receives various types of commands and data and transmits execution results.

A job control unit 402 executes a stacking job based on job data (job information) received from the control apparatus 40 via the communication circuit 420. The job data may include, for example, information indicating the content of the job, and may be stored in the memory 410.

The conveying control unit 406 starts the rotation of a motor M1 in accordance with a rotation command received from the control apparatus 40 (job processing unit 206). The conveying control unit 406 stops the rotation of the motor M1 in accordance with a stop command received from the control apparatus 40 (job processing unit 206). As a result, the conveying rollers 63 driven by the motor M1 rotate and stop rotating.

A flapper control unit 407 drives solenoids SL1 and SL2 in accordance with a switching command received for each sheet P from the control apparatus 40 (job processing unit 206) to switch between the flappers F1 and F2. As a result, the discharge destination of each sheet P is determined (the sheet P is guided and transported to either the sheet tray 61, the sheet tray 62, or a downstream stacking apparatus). The flappers F1 and F2 may be controlled based on an inspection result received from the inspection apparatus 50 instead of the switching command received from the control apparatus 40. For example, the flappers F1 and F2 may be controlled such that a sheet P determined to have failed the inspection (unacceptable) is discharged to the sheet tray 62a of the stacking apparatus 60a, and a sheet P determined to have passed the inspection (acceptable) is discharged to the sheet tray 61a or the stacking apparatus 60b.

In FIG. 1, the stacking apparatus 60b is a post-processing apparatus, and includes a post-processing control unit 408. The post-processing control unit 408 controls the post-processing unit 68 in accordance with a post-processing execution command received from the control apparatus 40.

### <Processing Procedure of Control Apparatus 40>

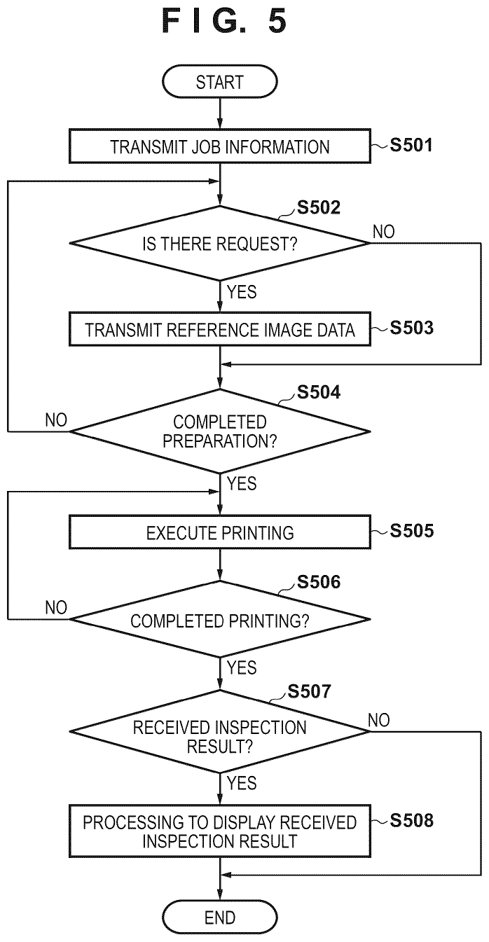

FIG. 5 is a flowchart showing an example of a procedure of processing executed by the CPU 201 of the control apparatus 40. When an instruction to start printing is received via the operation unit 20, the CPU 201 executes processing according to this procedure.

In step S501, the CPU 201 (job processing unit 206) creates job information for a print job and transmits the job information to the inspection apparatus 50. The job information includes sheet information, inspection settings, and discharge destination information, for example. The sheet information includes the size and number of sheets P. The job information may include, as part of the inspection settings, an instruction indicating that the inspection apparatus 50 is to execute an inspection job (i.e., information indicating that the print job is a job requiring image inspection to be performed on a sheet P). The discharge destination information can include, for example, identification information indicating whichever one of the stacking apparatuses 60a and 60b is to be the discharge destination, and identification information for a PASS tray and a FAIL tray. The PASS tray is a sheet tray onto which sheets P that have passed the image inspection performed by the inspection apparatus 50 (have been determined to be acceptable) are discharged. The FAIL tray is a sheet tray onto which sheets P that did not pass the image inspection performed by the inspection apparatus 50 (have been determined to be unacceptable) are discharged.

In step S502, the CPU 201 (inspection control unit 205) determines whether or not a request (reference image request) has been received from the inspection apparatus 50. This request is a signal for requesting the control apparatus 40 to transmit the reference image data 215. If the request has not been received, the CPU 201 moves to the processing of step S504. If the request has been received, the CPU 201 moves to the processing of step S503. In step S503, the CPU 201 (inspection control unit 205) reads out the reference image data 215 from the memory 210, transmits the read out data to the inspection apparatus 50, and moves to the processing of step S504. In this example, the reference image data 215 may be input image data used in image formation performed by the image forming apparatus 30.

In step S504, the CPU 201 (job processing unit 206) determines whether or not a notification of completion of preparation has been received from the inspection apparatus 50. If a notification of completion of preparation has not been received from the inspection apparatus 50, the CPU 201 returns to the processing of step S502. When a notification of completion of preparation is received from the inspection apparatus 50, the CPU 201 moves to the processing of step S505.

In step S505, the CPU 201 (job processing unit 206) controls the image forming apparatus 30 to execute printing on a sheet P. The sheet P on which the image was printed is discharged from the image forming apparatus 30 to the inspection apparatus 50. Then, in step S506, the CPU 201 (job processing unit 206) determines whether or not printing is complete, based on the print job being executed. In other words, the CPU 201 determines whether or not printing has been completed for all pages set in the print job. If there are remaining pages to be printed, the CPU 201 returns to the processing of step S505 and controls the image forming apparatus 30 to execute printing for the next page. If there are no remaining pages to be printed, the CPU 201 ends the execution of the print job and proceeds to step S507.

In step S507, the CPU 201 (inspection control unit 205) determines whether or not an inspection result has been received from the inspection apparatus 50. If the job information (step S501) does not instruct the inspection apparatus 50 to execute an inspection job, an inspection result is not received from the inspection apparatus 50. In this case, the CPU 201 ends the processing of this procedure.

If the job information (step S501) instructs the inspection apparatus 50 to execute an inspection job, an inspection result is received from the inspection apparatus 50. In this case, the CPU 201 moves from step S507 to step S508. In step S508, the CPU 201 (inspection control unit 205) performs display processing to display the received inspection result on the display device 21. Note that a configuration is possible in which the CPU 201 displays the inspection result only when there is a sheet P that has been determined to be unacceptable. When an instruction to end the display of the inspection result is received via the operation unit 20, the CPU 201 ends the display of the inspection result and ends the processing of this procedure.

### <Processing Procedure of Inspection Apparatus 50>

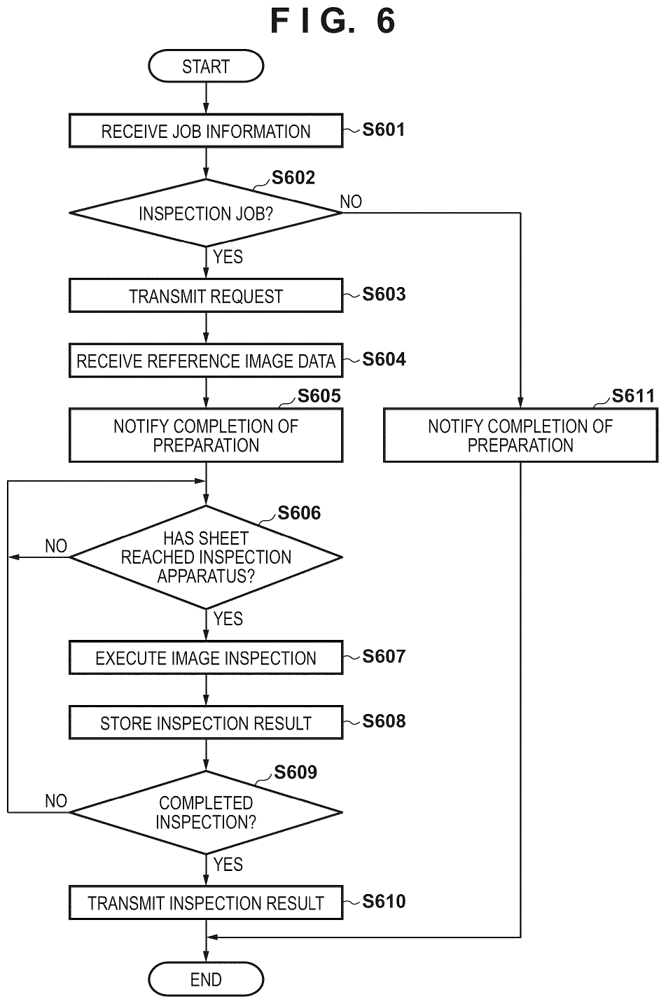

FIG. 6 is a flowchart showing an example of a procedure of processing executed by the CPU 301 of the inspection apparatus 50.

In step S601, the CPU 301 (the inspection unit 302) receives job information from the control apparatus 40. The job information may be stored in the memory 310. In the case where the job information is stored in the memory 310, the job information may be stored in the memory 310 as part of the setting data 314. Note that the CPU 301 transmits (transfers) the job information to the stacking apparatus 60a connected downstream of the inspection apparatus 50.

In step S602, the CPU 301 (inspection unit 302) analyzes the job information and determines whether or not the job information includes an instruction for executing an inspection job. If execution of an inspection job has not been instructed, the CPU 301 moves to the processing of step S611, notifies the control apparatus 40 of the completion of preparation, and ends the processing of this procedure. In this case, the inspection apparatus 50 executes a conveying job for conveying the sheet P to the downstream stacking apparatus 60a. If execution of an inspection job has been instructed, the CPU 301 moves from step S602 to step S603.

In step S603, the CPU 301 (inspection unit 302) transmits a request for the reference image data 215 to the control apparatus 40. In step S604, upon receiving the reference image data 215 from the control apparatus 40, the CPU 301 stores the received reference image data 215 in the memory 310. After that, in step S605, the CPU 301 notifies the control apparatus 40 that preparation is complete. Note that the preparation completion notification in step S605 or step S610 may also be transmitted to the downstream stacking apparatuses 60a to 60b. When the control apparatus 40 receives the notification of completion of preparation, the image forming apparatus 30 starts execution of printing on the sheet P. As a result, the sheet P starts to be discharged from the image forming apparatus 30 to the inspection apparatus 50.

In step S606, the CPU 301 (the inspection unit 302 and the conveying control unit 306) determines whether or not the sheet P has reached the inspection apparatus 50, based on the detection signal output from the sheet sensor 56. Arrival of the sheet P at the inspection apparatus 50 means that the sheet sensor 56 detects the leading edge of the sheet P. When the sheet P reaches the sheet sensor 56, the CPU 301 moves to the processing of step S607.

In step S607, the CPU 301 (the inspection unit 302 and the reading control unit 307) executes image inspection designated in accordance with the setting data 314. The reading control unit 307 generates the inspection image data 312 by reading the sheet P with the image sensors 54 and 55. Furthermore, the inspection unit 302 performs inspection on the inspection image data 312 in accordance with the inspection settings specified by the setting data 314. For example, the inspection unit 302 compares the inspection image data 312 with the reference image data 215 to determine whether or not the image formed on the sheet P meets the inspection standard.

After image inspection is executed, in step S608, the CPU 301 (inspection unit 302) stores the inspection result in the memory 310. Here, the CPU 301 (inspection unit 302) may store the inspection result in the memory 310 and also notify the inspection result to the downstream stacking apparatus 60a. In this case, the CPU 401 (flapper control unit 407) of the stacking apparatus 60 can perform control for the switching of the discharge destination of the sheet P between the PASS tray (e.g., the sheet tray 61a) and the FAIL tray (e.g., the sheet tray 62a) based on the inspection result received from the inspection apparatus 50. In other words, the CPU 401 can control the flappers F1 and F2 so as to discharge a sheet P determined to be acceptable onto the PASS tray, and discharge a sheet P determined to be unacceptable onto the FAIL tray.

Then, in step S609, the CPU 301 (inspection unit 302) determines whether or not image inspection is complete, based on the job information. If there are remaining pages to be inspected, the CPU 301 returns from step S609 to step S606 and waits for the arrival of the next sheet P. If there are no remaining pages to be inspected, the CPU 301 determines that image inspection is complete, and proceeds to step S610. In step S610, the CPU 301 (inspection unit 302) transmits the inspection result held in the RAM 310 to the control apparatus 40, and ends the execution of the inspection job, thereby ending the processing of this procedure. Note that the CPU 301 transmits the inspection image data 312 to the control apparatus 40 together with the inspection result to be transmitted to the control apparatus 40.

### <Print Setting Screen>

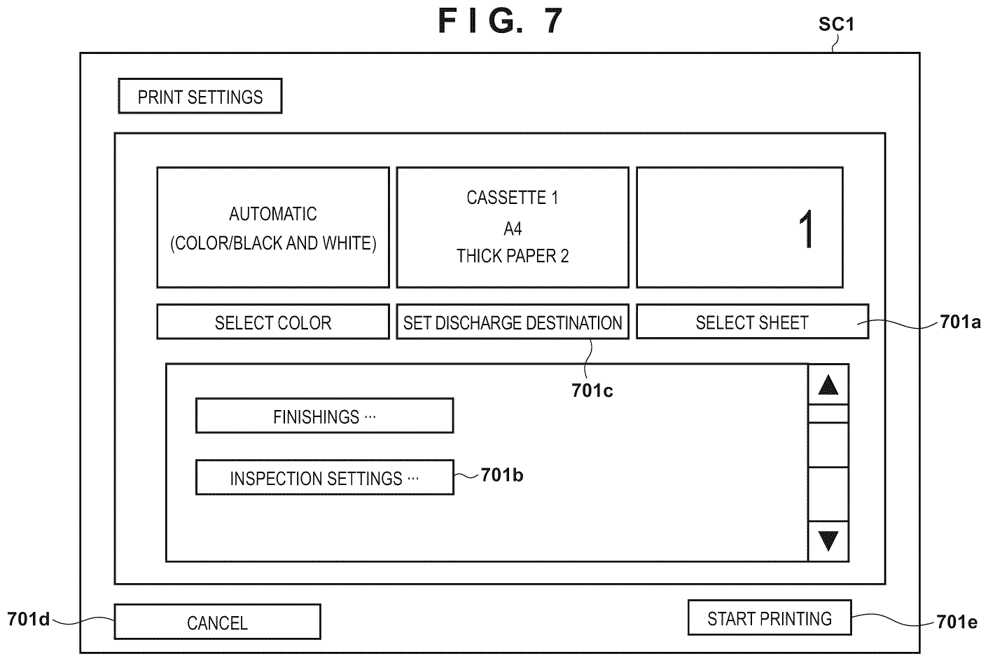

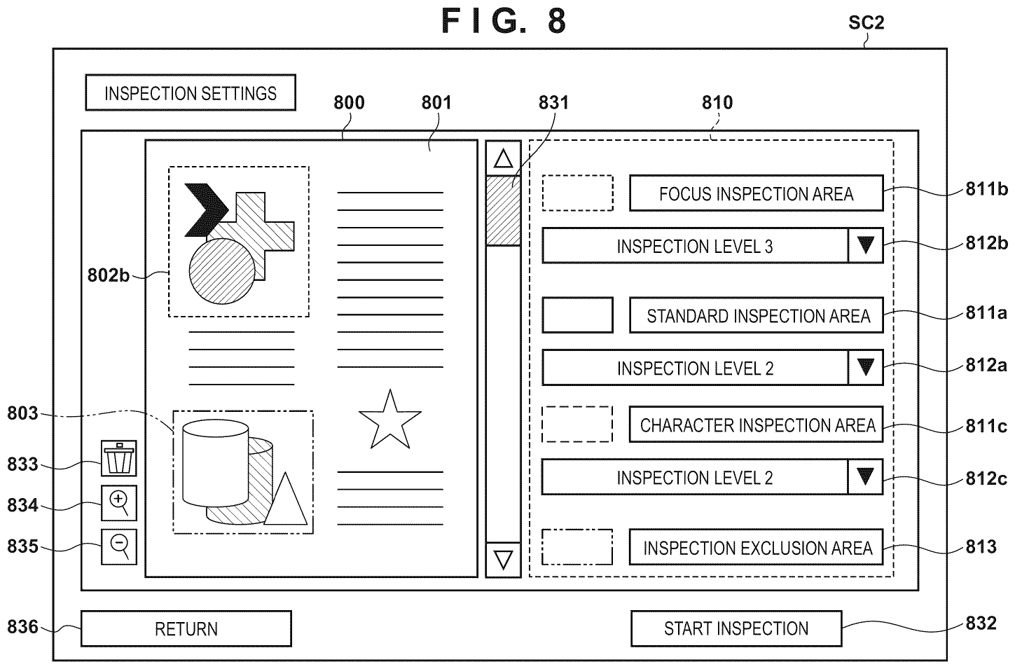

FIG. 7 shows a print setting screen SC1 as an example of the print setting screen according to the present embodiment. The print setting screen SC1 may be called a job input screen. The print setting screen SC1 is configured to receive print settings related to a print job that involves quality inspection (image inspection) to be performed on a printed material by the inspection apparatus 50. A button 701a is a button for designating the size of a sheet P to be printed (including the length of the sheet in the conveying direction), the basis weight of the sheet P, and a sheet cassette 11. A button 701b is a button for instructing a transition from the print setting screen SC1 to an inspection setting screen SC2 (FIG. 8). In the inspection setting screen SC2, for example, the inspection area where quality inspection is to be executed by the inspection apparatus 50 is set as an inspection setting for the quality inspection. A button 701c is a button for instructing a transition from the print setting screen SC1 to a discharge destination setting screen. In the discharge destination setting screen, for example, a discharge destination for FAIL sheets and a discharge destination for PASS sheets are set. A button 701d is a button for instructing the cancelation of setting content.

When the button 701d is pressed by an operator (user), a transition from the print setting screen SC1 to a predetermined initial screen is performed. A button 701e is a button for instructing the start of printing. When the button 701e is pressed by the operator, the CPU 201 of the control apparatus 40 starts executing processing according to the procedure of FIG. 5. Note that when the button 701e is pressed to start the execution of a print job, the job information transmitted from the control apparatus 40 to the inspection apparatus 50 does not include an instruction indicating that the inspection apparatus 50 is to execute an inspection job. In other words, the print job is executed as a job that does not require image inspection of the sheet P.

### <Inspection Setting Screen>

FIG. 8 shows an inspection setting screen SC2 as an example of an inspection setting screen according to the present embodiment. The inspection setting screen SC2 is displayed on the display device 21 when the button 701e on the print setting screen SC1 is pressed. The inspection setting screen SC2 is a screen for receiving an instruction from the operator for setting an inspection area where quality inspection is to be executed by the inspection apparatus 50. A reference image 801, an inspection area 802a, and the like are displayed in a display area 800 (first display area). In this example, the reference image 801 and the inspection area 802a are displayed in a superimposed manner in the display area 800. In the example of FIG. 8, the reference image 801 displayed in the display area 800 has a size corresponding to an A4 size sheet, which is a standard size.

A scroll bar 831 may be arranged in the vicinity of the display area 800. For example, in the case where the sub-scanning direction of the reference image 801 displayed in the display area 800 matches the vertical direction of the display area 800, the scroll bar 831 is used to move the reference image 801 parallel to the sub-scanning direction. A button 833 is a button for discarding existing settings set for the reference image 801. An enlargement button 834 is a button for enlarging the reference image 801 displayed in the display area 800. A reduction button 835 is a button for reducing the size of the reference image 801 displayed in the display area 800.

The inspection area and an inspection exclusion area are set via a mouse or a touch panel, which is a part of the input device 22. In this example, the inspection areas that can be set include a standard inspection area, a focus inspection area, and a character inspection area. The standard inspection area is, for example, an inspection area in which inspection of standard content is executed, and is applied to the entire reference image 801 displayed in the display area 800. In this example, a focus inspection area, a character inspection area, and an inspection exclusion area can be set individually inside the standard inspection area.

A menu 812a is a pull-down menu for setting the inspection level (inspection accuracy level) to be applied to the standard inspection area. A pull-down menu may also be called a drop-down list. In this example, the inspection level 1 has the lowest inspection accuracy, and the inspection accuracy increases as the inspection level number increases.

An inspection area 802b is a focus inspection area that is set by pressing a button 811b in a display area 810 (second display area). The focus inspection area is, for example, an inspection area where high-accuracy inspection is to be executed. In this example, the focus inspection area is indicated by a dashed-line box. A menu 812b is a pull-down menu for setting the inspection level (inspection accuracy) to be applied to the inspection area 802b.

In addition to the standard inspection area and the focus inspection area, a character inspection area not shown in the display area 800 in FIG. 8 can be set by pressing a button 811c. The character inspection area is an inspection area where inspection is to be executed with use of, for example, recognition of characters, a barcode, or the like. Also, the inspection exclusion area 803 is set by pressing a button 813, and is an area in which inspection is not to be executed. There is no need to perform high-accuracy inspection for cylindrical shapes and triangular shapes. Therefore, an area including such shapes may be set as an inspection exclusion area.

In this way, an individual inspection level can be set for each area included in the print target. This allows the user to set appropriate acceptance standards. As a result, a printed material having an acceptable quality is determined to have passed inspection, thereby reducing unnecessary reprinting and improving productivity. Moreover, the number of sheets P that are wasted is reduced. Furthermore, by being able to set an individual inspection level for each area included in the print target, the amount of memory and processing power required for inspection can be reduced compared with the case of always performing inspection with the highest accuracy level on the entire image or for each area.

A button 836 is a button for instructing a return to the print setting screen SC1, which is the original screen. When the button 836 is pressed, the inspection settings input through the inspection setting screen SC2 are discarded. A button 832 is a button for instructing the start of inspection. When the button 832 is pressed by the operator, the CPU 201 of the control apparatus 40 starts executing processing according to the procedure of FIG. 5. When the button 832 is operated to start the execution of a print job, the job information transmitted from the control apparatus 40 to the inspection apparatus 50 includes an instruction indicating that the inspection apparatus 50 is to execute an inspection job. In other words, the print job is executed as a job requiring image inspection of a sheet P.

In the inspection setting screen SC2 in FIG. 8, the button 811, the menu 812, and the button 813 constitute operation objects (an operation object group) for accepting inspection settings for image inspection to be performed on an inspection image. In the present embodiment, the operation objects are configured to receive at least either a setting of the inspection content with respect to a reference image or a setting of the inspection area where image inspection is to be executed. The inspection setting screen SC2 is configured as a screen including the first display area (display area 800) that displays a reference image, and the second display area (display area 810) that displays the above-mentioned operation objects for accepting inspection settings for image inspection of the inspection image.

### <Examples of Layout of Inspection Setting Screen>

In the present embodiment, the display direction (display orientation) of the reference image is determined (controlled) according to the size of the reference image, such that the reference image is displayed larger in the inspection setting screen SC2 (setting screen). Specifically, the layout of the first display area (display area 800) that displays the reference image and the second display area (display area 810) that displays the operation objects for accepting inspection settings for the image inspection is determined such that the reference image is displayed larger in the inspection setting screen SC2. Also, in a second embodiment described later, an example is described in which, in the case where the layout of the reference image (first display area) and the operation objects (second display area) in the inspection setting screen SC2 is set in advance, the display direction of the reference image in the inspection setting screen SC2 is determined (controlled) in accordance with the pre-set arrangement. Such display control enables the user to appropriately set the inspection content for the reference image in the inspection setting screen SC2, thereby making it easier for the user to set the inspection settings.

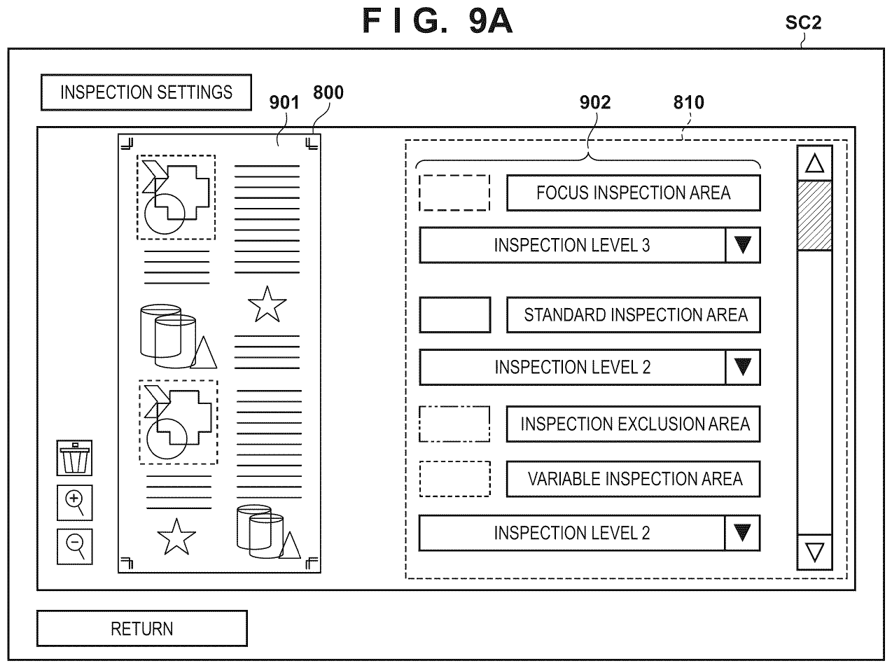

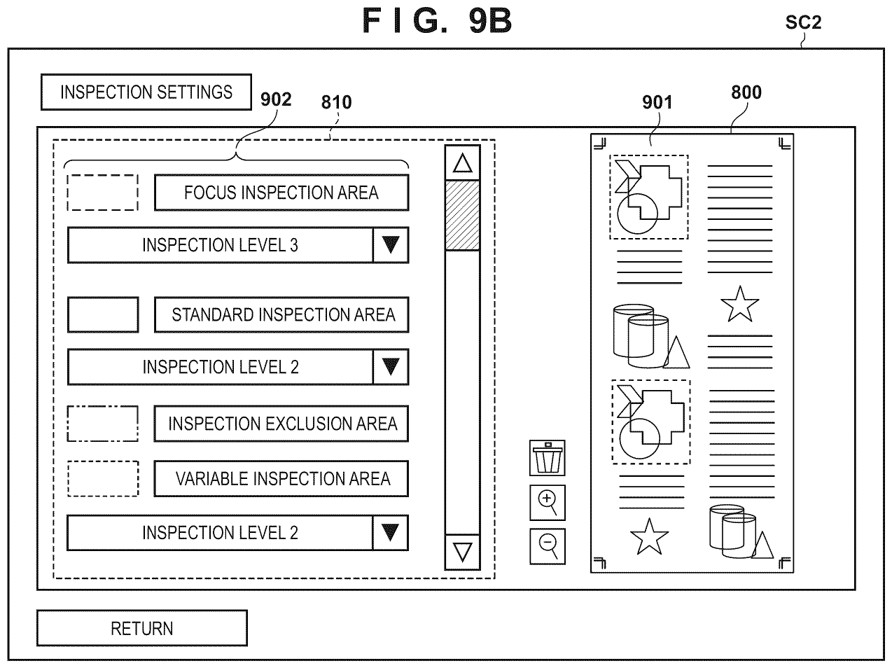

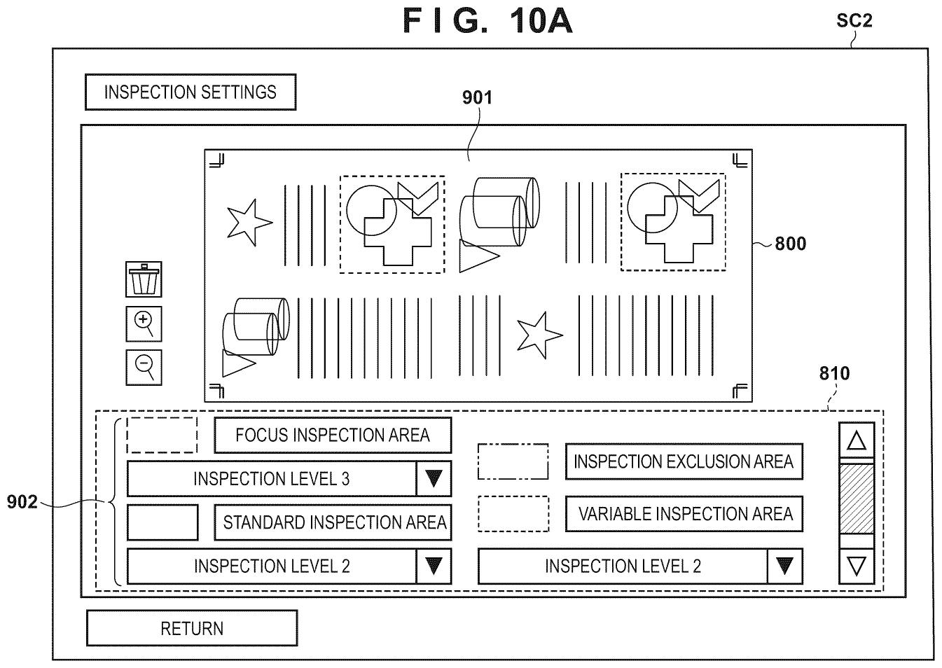

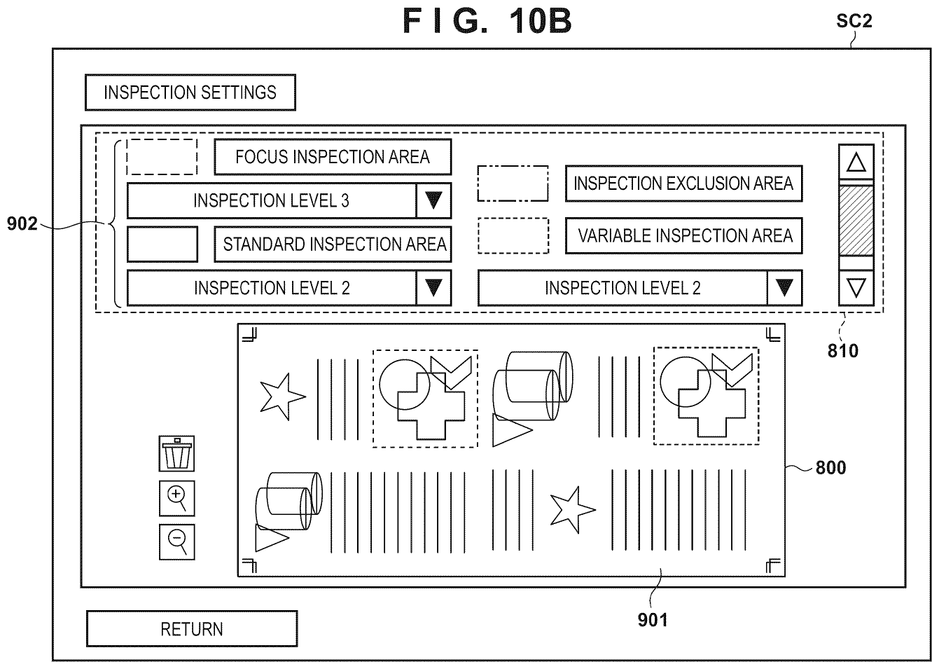

FIGS. 9A, 9B, 10A, and 10B show examples of layouts of the inspection setting screen SC2. In the examples of FIGS. 9A, 9B, 10A, and 10B, a reference image 801 of a size corresponding to a long sheet, which is a non-standard size, is displayed in the display area 800. In the present embodiment, a long-sized sheet corresponds to a sheet whose length in the conveying direction (sub-scanning direction) exceeds a predetermined length. For example, the length of a long-sized sheet P in the conveying direction (sub-scanning length) is greater than 900 mm. A long-sized sheet may also be called long paper. Also, a long-sized sheet may be defined as a sheet whose length in the conveying direction (sub-scanning direction) exceeds a predetermined length and whose long-side length is greater than or equal to a predetermined number of times (e.g., three times) the short-side length.

FIGS. 9A and 9B show examples of layouts in which a reference image 901 and operation objects 902 are arranged in the inspection setting screen SC2 at different positions in the horizontal direction of the inspection setting screen. FIG. 9A shows an example of a layout in which the reference image 901 (display area 800, first display area) is arranged on the left side in the horizontal direction of the inspection setting screen SC2, and the operation objects 902 (display area 810, second display area) are arranged on the right side. FIG. 9B shows an example of a layout in which the reference image 901 (display area 800, first display area) is arranged on the right side in the horizontal direction of the inspection setting screen SC2, and the operation objects 902 (display area 810, second display area) are arranged on the left side.

FIGS. 10A and 10B show examples of layouts in which the reference image 901 and the operation objects 902 are arranged in the inspection setting screen SC2 at different positions in the vertical direction of the inspection setting screen. FIG. 10A shows an example of a layout in which the reference image 901 (display area 800, first display area) is arranged on the upper side in the vertical direction of the inspection setting screen SC2, and the operation objects 902 (display area 810, second display area) are arranged on the lower side. FIG. 10B shows an example of a layout in which the reference image 901 (display area 800, first display area) is arranged on the lower side in the vertical direction of the inspection setting screen SC2, and the operation objects 902 (display area 810, second display area) are arranged on the upper side.

In the layout of the inspection setting screen SC2 in FIGS. 9A and 9B, the long-sized reference image 901 is displayed vertically (i.e., the sides of the reference image 901 parallel to the sheet conveying direction are aligned along the vertical direction of the inspection setting screen SC2). Also, in the layout of the inspection setting screen SC2 in FIGS. 10A and 10B, the long-sized reference image 901 is displayed horizontally (i.e., the sides of the reference image 901 parallel to the sheet conveying direction are aligned along the horizontal direction of the inspection setting screen SC2). In the present embodiment, the inspection setting screen SC2 is configured as a screen whose horizontal length is longer than the vertical length. In this case, the long-sized reference image 901 can be displayer larger in the inspection setting screen SC2 when the reference image 901 is displayed horizontally as in FIGS. 10A and 10B rather than being displayed vertically as in FIGS. 9A and 9B.

In the present embodiment, if the size of the reference image is not a long size (e.g., if the size is A4), the reference image can be displayed at a sufficient size if the reference image is displayed vertically as shown in FIG. 8, and there is no need for the reference image to be displayed horizontally in the inspection setting screen SC2.

### <Inspection Setting Screen Display Control>

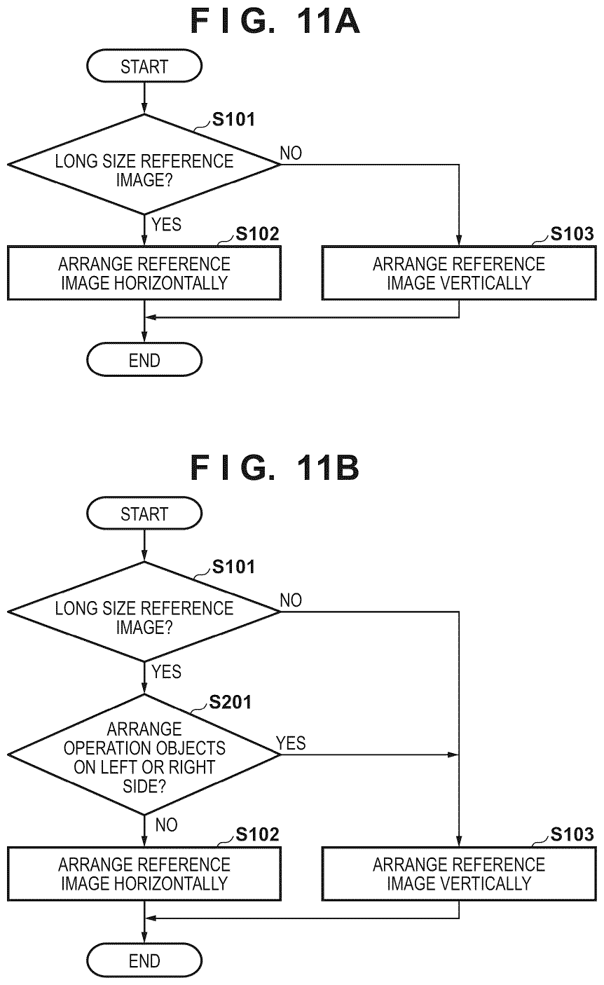

FIG. 11A is a flowchart showing an example of a procedure of processing for determining the display direction (display orientation) of the reference image, which is executed when the CPU 201 (inspection control unit 205) displays the inspection setting screen SC2 in the present embodiment.

In step S101, the CPU 201 determines whether or not the size of the reference image to be displayed in the inspection setting screen SC2 is a long size (that is, whether or not the size corresponds to a sheet whose length in the conveying direction exceeds a predetermined length). If the size of the reference image is a long size, the CPU 201 moves to the processing of step S102.

In step S102, the CPU 201 determines the display direction of the reference image such that the reference image is arranged horizontally as shown in FIGS. 10A and 10B, and displays the inspection setting screen SC2, thereby ending the processing of this procedure. In other words, the CPU 201 displays the reference image such that the sides of the reference image parallel to the sheet conveying direction are aligned along the horizontal direction of the inspection setting screen SC2. At this time, the CPU 201 displays the entire reference image on the inspection setting screen SC2 such that the display size is the largest when the entire reference image is displayed in the determined display direction. Note that the user may set in advance which of the layouts in FIG. 10A and FIG. 10B is to be applied.

On the other hand, if the size of the reference image is not a long size, the CPU 201 moves from step S101 to step S103. In step S103, the CPU 201 determines the display direction of the reference image such that the reference image is arranged vertically as shown in FIG. 8, and displays the inspection setting screen SC2, thereby ending the processing of this procedure. In other words, the CPU 201 displays the reference image such that the sides of the reference image parallel to the sheet conveying direction are aligned along the vertical direction of the inspection setting screen SC2. Note that the layout in FIG. 8 (FIG. 9A) may be set in advance as a standard layout (default layout) to be applied to reference images that are not long in size.

The inspection setting screen SC2, on which the display control has been performed as described, is displayed as follows, for example. When a sheet having a first length in the conveying direction is read, the first display area (display area 800) and the second display area (display area 810) are displayed in a first state, and when a sheet having a second length in the conveying direction is read, the first display area and the second display area are displayed in a second state. At this time, the first length is longer than the second length, and in the first state, the first display area and the second display area are displayed side by side in the horizontal direction, and in the second state, the first display area and the second display area are displayed side by side in the vertical direction.

As described above, in the image forming system 100 of the present embodiment, the image forming apparatus 30 forms an image on a sheet. The inspection apparatus 50 performs inspection on the printed material, which includes the sheet and the image formed on the sheet by the image forming apparatus 30, based on an inspection image obtained by reading the printed material. The CPU 201 (inspection control unit 205) of the control apparatus 40 displays, on the display device 21, the inspection setting screen SC2 that includes the first display area (display area 800) that displays a reference image based on which image inspection is performed by the inspection apparatus 50, and the second display area (display area 810) that displays operation objects for accepting inspection settings for the image inspection. At this time, the CPU 201 (inspection control unit 205) determines the arrangement of the first display area and the second display area (the display direction of the reference image) on the inspection setting screen SC2 according to the size of the reference image. For example, in the case where the size of the reference image is a long size, the CPU 201 (inspection control unit 205) determines the arrangement of the first display area and the second display area such that the reference image is displayed in such a manner that the sides of the reference image parallel to the sheet conveying direction are aligned along the horizontal direction of the setting screen (i.e., the reference image is displayed horizontally).

According to such display control, when the size of the reference image is a long size, the reference image can be displayed larger in the inspection setting screen SC2. This allows the user to appropriately set the content of the inspection for the reference image using the operation objects 902 in the inspection setting screen SC2. In this way, according to the present embodiment, it is possible to perform display control on the inspection setting screen SC2 so as to make it easier for the user to set inspection settings.

In the present embodiment, the display control performed on the inspection setting screen SC2 in the image forming system 100 is performed by the CPU 201 (inspection control unit 205) of the control apparatus 40, but such display control may be performed by the inspection apparatus 50. In other words, the CPU 301 (setting unit 303) of the inspection apparatus 50 may function as a display control unit. In this case, the inspection apparatus 50 may be provided with an input device and a display device (display), or the operation unit 20 (display device 21 and input device 22) of the image forming system 100 may be used by the CPU 301 (setting unit 303).

### Second Embodiment

A second embodiment is a variation of the first embodiment. In the second embodiment, description is given for processing for determining the display direction of the reference image in the inspection setting screen SC2 in a case where the layout of the inspection setting screen SC2 is set in advance by the user. Descriptions given for matter in the first embodiment will serve as descriptions for matter in the second embodiment that is in common with the first embodiment.

### <Layout Setting for Inspection Setting Screen>

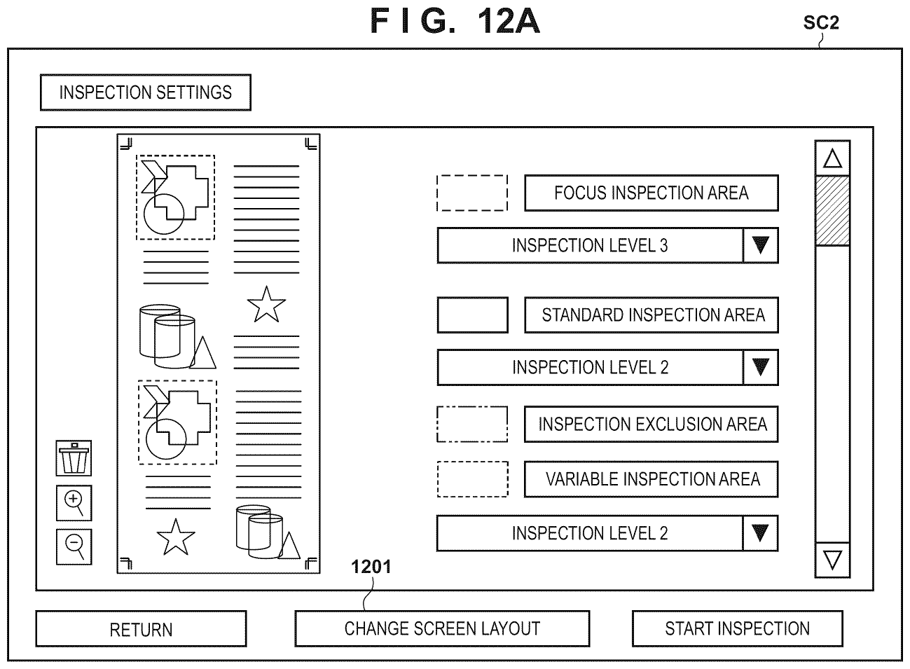

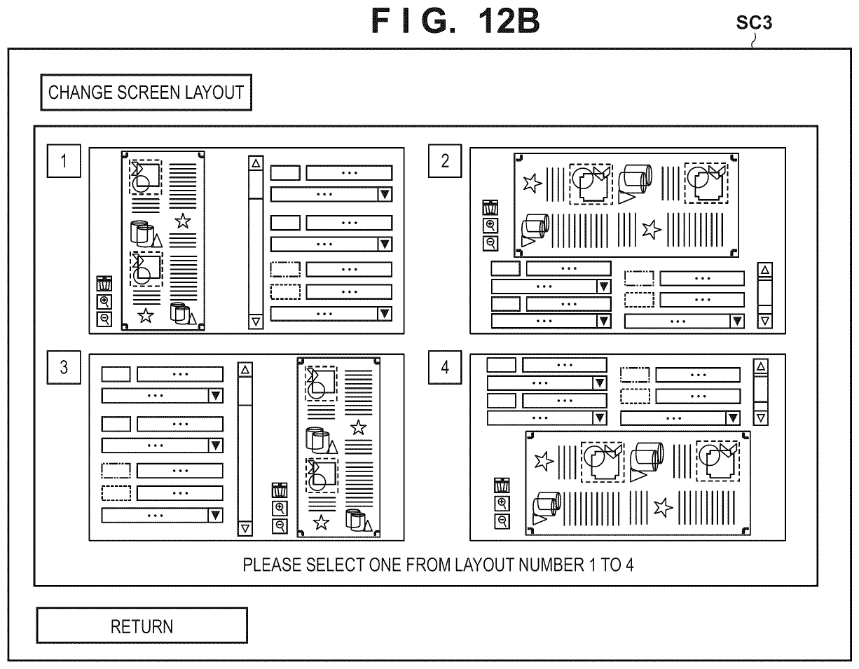

FIG. 12A shows an example of the inspection setting screen SC2. The inspection setting screen SC2 of this example includes a button 1201 for instructing a change in the layout of the inspection setting screen SC2. When the button 1201 is pressed by the user, the display screen of the display device 21 transitions to a layout setting screen SC3 of FIG. 12B.

The layout setting screen SC3 is configured such that the user can select one layout from among layouts 1 to 4. The layouts 1 and 3 correspond to the layouts of FIGS. 9A and 9B. The layouts 2 and 4 correspond to the layouts of FIGS. 10A and 10B. On the layout setting screen SC3, the user can select a layout to be applied to the inspection setting screen SC2. The layout setting selected by the user is stored in the memory 210 and used by the CPU 201.

In this manner, the layout setting screen SC3 can accept a first layout (layouts 1 and 3) in which the reference image 901 and the operation objects 902 are arranged in the inspection setting screen SC2 at different positions in the horizontal direction of the setting screen SC2. The layout setting screen SC3 can further accept a second layout (layouts 2 and 4) in which the reference image 901 and the operation objects 902 are arranged in the inspection setting screen SC2 at different positions in the vertical direction of the inspection setting screen SC2. In the present embodiment, the layout setting screen SC3 functions as an example of an acceptance unit that accepts a setting of the layout of the inspection setting screen SC2.

### <Inspection Setting Screen Display Control>

FIG. 11B is a flowchart showing an example of a procedure of processing for determining the display direction (display orientation) of a reference image, which is executed when the CPU 201 (inspection control unit 205) displays the inspection setting screen SC2 in the present embodiment.

In step S101, the CPU 201 determines whether or not the size of the reference image to be displayed in the inspection setting screen SC2 is a long size (i.e., whether or not the size corresponds to a sheet whose length in the conveying direction exceeds a predetermined length), as in the first embodiment. If the size of the reference image is a long size, the CPU 201 moves to the processing of step S201.

In steps S201, S102, and S103, the CPU 201 determines the arrangement of the first display area and the second display area by switching, in accordance with the arrangement of the operation objects 902 in the inspection setting screen SC2, between displaying the reference image 901 horizontally (the sides of the reference image that are parallel to the sheet conveying direction are aligned along the horizontal direction of the inspection setting screen SC2) or vertically (the sides of the reference image that are parallel to the sheet conveying direction are aligned along the vertical direction of the inspection setting screen SC2).

In step S201, the CPU 201 refers to the layout setting of the inspection setting screen SC2 stored in the memory 210, and determines whether or not a layout has been set in which the operation objects 902 are arranged on the left or right side of the reference image 901. In other words, the CPU 201 determines whether or not a layout has been set in which the reference image 901 and the operation objects 902 are arranged in the inspection setting screen SC2 at different positions in the horizontal direction of the inspection setting screen SC.

In the case where a layout has been set in which the operation objects 902 are arranged on the left or right side of the reference image 901, the CPU 201 moves from step S201 to step S103. In this case, the layout of FIG. 9A or FIG. 9B is set. In step S103, the CPU 201 determines the display direction of the reference image such that the reference image is arranged vertically, and displays the inspection setting screen SC2 with the set layout, thereby ending the processing of this procedure.

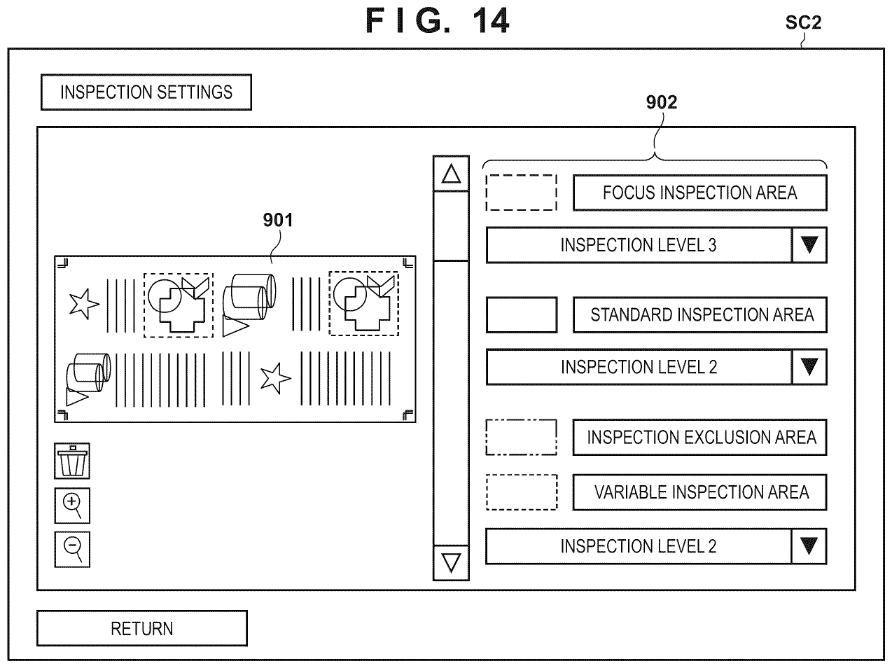

Here, FIG. 14 shows an example of the inspection setting screen SC2 in a comparative example in which the reference image 901 is arranged horizontally when the layout of FIG. 9A (a layout in which the operation objects 902 are arranged on the left or right side of the reference image 901) is set. The reference image 901 is displayed smaller in this comparative example than in the example of FIG. 9A. In the present embodiment, when a layout in which the operation objects 902 are arranged on the left or right of the reference image 901 is applied, the display direction of the reference image is determined such that the reference image is arranged vertically in order to display the reference image 901 larger.

On the other hand, if a layout in which the operation objects 902 are arranged on the left or right side of the reference image 901 has not been set, the CPU 201 moves from step S201 to step S102. In this case, the layout of FIG. 10A or FIG. 10B is set. In step S102, the CPU 201 determines the display direction of the reference image such that the reference image is arranged horizontally, and displays the inspection setting screen SC2 with the set layout, thereby ending the processing of this procedure.

On the other hand, if the size of the reference image is not a long size, the CPU 201 moves from step S101 to step S103, similarly to the first embodiment. In step S103, the CPU 201 determines the display direction of the reference image such that the reference image is arranged vertically as shown in FIG. 8, and displays the inspection setting screen SC2, thereby ending the processing of this procedure.

As described above, according to the present embodiment, it is possible to realize display control in which, when the size of the reference image is a long size, the reference image is displayed larger in the inspection setting screen SC2 in accordance with the arrangement of the operation objects 902 in the inspection setting screen SC2. This allows the user to appropriately set the content of the inspection for the reference image using the operation objects 902 in the inspection setting screen SC2. In this way, according to the present embodiment, it is possible to perform display control on the inspection setting screen SC2 so as to make it easier for the user to set inspection settings.

### Third Embodiment

A third embodiment is a variation of the first and second embodiments. In the third embodiment, display control for the inspection setting screen SC2 described in the first and second embodiments is applied to display control for the inspection result screen (inspection result confirmation screen). Descriptions given for matter in the first and second embodiments will serve as descriptions for matter in the third embodiment that is in common with the first and second embodiments.

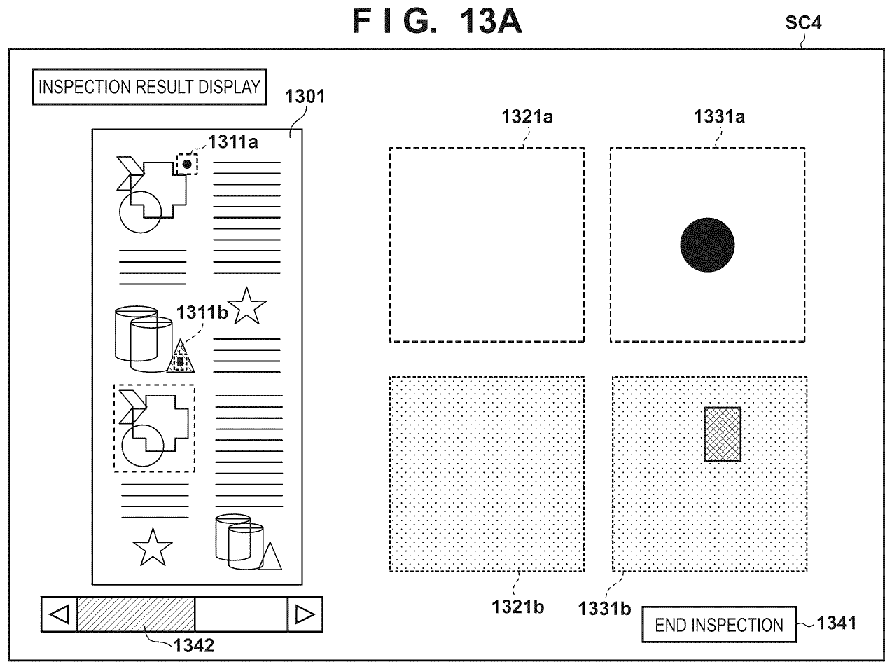

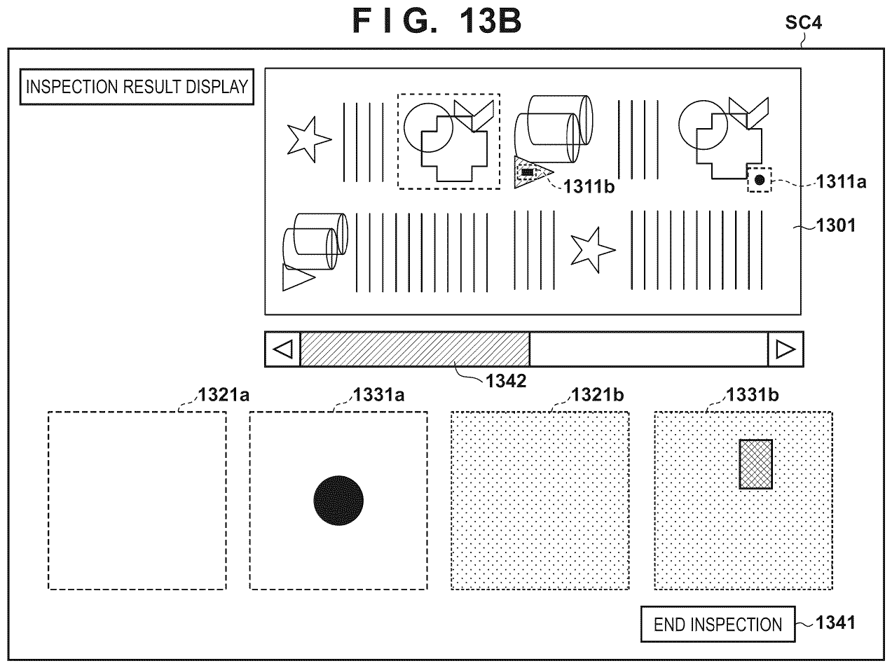

FIGS. 13A and 13B show an inspection result screen SC4 as an example of the inspection result screen (inspection result confirmation screen) according to the present embodiment. The inspection result screen SC4 is an example of a screen that is displayed on the display device 21 in the case where the inspection apparatus 50 performs quality inspection on a printed material including a long-sized sheet (long paper) and the sheet is determined to be unacceptable. In the case where there is a sheet P that has been determined to be unacceptable as a result of the quality inspection performed by the inspection apparatus 50, the inspection result screen SC4 is displayed on the display device 21 in step S508. Upon receiving the inspection result from the inspection apparatus 50, the inspection control unit 205 creates the inspection result confirmation screen SC4 based on the inspection result and causes the display device 21 to display the created screen. Note that the inspection control unit 205 generates an inspection image to be displayed in the inspection result screen SC2 based on the inspection image data 312 received from the inspection apparatus 50 together with the inspection result.

FIG. 13A shows an example of a layout in which an inspection image 1301 and enlarged images 1321 and 1331 are arranged in the inspection result screen SC4 (confirmation screen) at different positions in the horizontal direction of the inspection result screen. FIG. 13A is an example of a layout in which the inspection image 1301 (first display area) is arranged on the left side in the horizontal direction of the inspection result screen SC4, and the enlarged images 1321 and 1331 (second display area) are arranged on the right side, and corresponds to the layout of the inspection setting screen SC2 in FIG. 9A. Similarly to FIG. 9B, a layout can also be realized in which the arrangement of the inspection image 1301 and the enlarged images 1321 and 1331 is reversed.

FIG. 13B shows an example of a layout in which the inspection image 1301 and the enlarged images 1321 and 1331 are arranged in the inspection result screen SC4 at different positions in the vertical direction of the inspection result screen. FIG. 13B is an example of a layout in which the inspection image 1301 (first display area) is arranged on the upper side in the vertical direction of the inspection result screen SC4, and the enlarged images 1321 and 1331 (second display area) are arranged on the lower side, and corresponds to the layout of the inspection setting screen SC2 in FIG. 10A. Similarly to FIG. 10B, a layout can also be realized in which the arrangement of the inspection image 1301 and the enlarged images 1321 and 1331 is reversed.

Display items 1311 (1311a and 1311b) are displayed in a superimposed manner on the inspection result screen SC4 of FIGS. 13A and 13B. The display item 1311 indicates the location where an abnormality was detected in inspection image 1301. The enlarged image 1321 is an enlarged image of an image (normal image) of a region including the position indicated by the display item 1311 in the reference image. The enlarged image 1331 is an enlarged image of an area (abnormal image) including the position indicated by the display item 1311 in the inspection image 1301. The enlarged image 1321 and the enlarged image 1331 are displayed at the same enlargement ratio (magnification).

In this example, two abnormalities corresponding to the display items 1311a and 1311b are detected, and the corresponding enlarged images 1321 and 1331 are displayed in the inspection result screen SC4. A scroll bar 1342 is used to switch between pages in which an abnormality has been detected (determination result is unacceptable). As the pages are switched, the inspection result screen SC4 is updated such that enlarged images 1321 and 1331 corresponding to the abnormalities in the pages are displayed. The display item 1311 and the enlarged images 1321 and 1331 are associated with each other by line type (dashed line, dotted line, etc.), but the association may be made by, for example, color.

A button 1341 is a button for ending the printed material quality inspection. When the user has checked the inspection result on the inspection result screen SC4 and pressed the button 1341, inspection control unit 205 ends the printed material quality inspection.

### <Inspection Result Screen Display Control>

In the present embodiment, the processing of determining the display direction of the inspection image, which is executed by the CPU 201 (inspection control unit 205) when displaying the inspection result screen SC4, is realized in a manner similar to that of the processing of determining the display direction of the reference image in the first embodiment (FIGS. 11A and 11B). The above-given description of the processing for determining the display direction of the reference image can serve as a description for the inspection result screen SC4 by replacing “reference image” with “inspection image”, replacing “inspection setting screen SC2” with “inspection result screen SC4”, and replacing “operation objects”with “enlarged images”.

As described above, in the image forming system 100 of the present embodiment, the image forming apparatus 30 forms an image on a sheet. The inspection apparatus 50 performs inspection on the printed material, which includes the sheet and the image formed on the sheet by the image forming apparatus 30, based on an inspection image obtained by reading the printed material. In the case where an abnormal image is found in the inspection result of image inspection performed by the inspection apparatus 50, the CPU 201 (inspection control unit 205) of the control apparatus 40 displays, on the display device 21, an inspection result confirmation screen (inspection result screen SC4) that includes the first display area for displaying the inspection image and a second display area for displaying an enlarged image of an abnormal image corresponding to the inspection image. At this time, the CPU 201 (inspection control unit 205) determines the arrangement of the first display area and the second display area (display direction of the inspection image) in the inspection result screen SC4, in accordance with the size of the inspection image. For example, when the size of the inspection image is a long size, the CPU 201 (inspection control unit 205) determines the arrangement of the first display area and the second display area such that the inspection image is displayed in such a manner that the sides of the inspection image parallel to the sheet conveying direction are aligned along the horizontal direction of the setting screen (i.e., the inspection image is displayed horizontally).

With such display control, when the size of the inspection image is a long size, it is possible to display the inspection image larger in the inspection result screen SC4. This makes it possible to easily check the position of the abnormalities (abnormal images) corresponding to the enlarged images 1321 and 1331 in the inspection result screen SC4. In this way, according to the present embodiment, it is possible to control the display of the inspection result screen SC4 such that the user can more easily check the inspection result.

Note that although the display control of the inspection setting screen SC4 in the image forming system 100 is performed by the CPU 201 (inspection control unit 205) of the control apparatus 40 in the present embodiment, such display control may be performed by the inspection apparatus 50. In other words, the CPU 301 (setting unit 303) of the inspection apparatus 50 may function as a display control unit. In this case, the inspection apparatus 50 may be provided with an input device and a display device (display), or the operation unit 20 (display device 21 and input device 22) of the image forming system 100 may be used by the CPU 301 (setting unit 303).

According to the present disclosure, it is possible to control the display of a setting screen such that inspection settings can be more easily set by a user.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-135034, filed Aug. 13, 2024, which is hereby incorporated by reference herein in its entirety.

What is claimed is:

1. An inspection apparatus comprising:
an inspection unit configured to perform inspection on an inspection image obtained by reading a sheet on which an image is formed, based on a reference image and the inspection image;
a display unit; and
a display control unit configured to display, on the display unit, a setting screen including a first display area that displays the reference image and a second display area that displays an operation object for accepting an inspection setting for the inspection,
wherein the display control unit determines an arrangement of the first display area and the second display area in the setting screen in accordance with a size of the reference image.

2. The inspection apparatus according to claim 1,
wherein in a case where the size of the reference image is a size corresponding to a sheet whose length in a conveying direction exceeds a predetermined length, the display control unit determines the arrangement of the first display area and the second display area such that the reference image is displayed in such a manner that a side of the reference image parallel to the conveying direction is aligned along a horizontal direction of the setting screen.

3. The inspection apparatus according to claim 2,
wherein in a case where the size of the reference image is not a size corresponding to a sheet whose length in the conveying direction exceeds the predetermined length, the display control unit determines the arrangement of the first display area and the second display area such that the reference image is displayed in such a manner that the side of the reference image parallel to the conveying direction is aligned along a vertical direction of the setting screen.

4. The inspection apparatus according to claim 1,
wherein in a case where the size of the reference image is a size corresponding to a sheet whose length in a conveying direction exceeds a predetermined length, the display control unit determines the arrangement of the first display area and the second display area by switching, in accordance with an arrangement of the operation object in the setting screen, between displaying the reference image in such a manner that a side of the reference image parallel to the conveying direction is aligned along a horizontal direction of the setting screen and displaying the reference image in such a manner that the side of the reference image parallel to the conveying direction is aligned along a vertical direction of the setting screen.

5. The inspection apparatus according to claim 4,
wherein in a case where the size of the reference image is a size corresponding to a sheet whose length in the conveying direction exceeds the predetermined length, if a layout has been set in which the reference image and the operation object are arranged in the setting screen at different positions in the horizontal direction of the setting screen, the display control unit displays the reference image in such a manner that the side of the reference image parallel to the conveying direction is aligned along the vertical direction of the setting screen.

6. The inspection apparatus according to claim 5,
wherein in a case where the size of the reference image is a size corresponding to a sheet whose length in the conveying direction exceeds the predetermined length, if a layout has not been set in which the reference image and the operation object are arranged in the setting screen at different positions in the horizontal direction of the setting screen, the display control unit displays the reference image in such a manner that the side of the reference image parallel to the conveying direction is aligned along the horizontal direction of the setting screen.

7. The inspection apparatus according to claim 4, further comprising:
an acceptance unit configured to accept a setting of a layout of the setting screen,
wherein the acceptance unit is configured to accept a first layout in which the reference image and the operation object are arranged in the setting screen at different positions in the horizontal direction of the setting screen, and a second layout in which the reference image and the operation object are arranged in the setting screen at different positions in the vertical direction of the setting screen.

8. The inspection apparatus according to claim 7,
wherein in a case where the size of the reference image is a size corresponding to a sheet whose length in the conveying direction exceeds the predetermined length,
if the first layout has been set, the display control unit displays the reference image in such a manner that the side of the reference image parallel to the conveying direction is aligned along the vertical direction of the setting screen, and
if the second layout has been set, the display control unit displays the reference image in such a manner that the side of the reference image parallel to the conveying direction is aligned along the horizontal direction of the setting screen.

9. The inspection apparatus according to claim 1,
wherein the display control unit displays an entirety of the reference image in the setting screen in such a manner that a display size of the entirety of the reference image is largest with the arrangement determined for the first display area and the second display area.

10. The inspection apparatus according to claim 1,
wherein the operation object is configured to accept at least one of a setting of inspection content for the reference image and a setting of an inspection area in which the inspection is to be executed.

11. An inspection apparatus comprising:
an inspection unit configured to perform inspection on an inspection image obtained by reading a sheet on which an image is formed;
a display unit; and
a display control unit configured to, in a case where an abnormal image is included in an inspection result, display, on the display unit, an inspection result confirmation screen including a first display area that displays the inspection image and a second display area that displays an enlarged image obtained by enlarging the abnormal image in the inspection image,
wherein the display control unit determines an arrangement of the first display area and the second display area in the confirmation screen in accordance with a size of the inspection image.

12. The inspection apparatus according to claim 11,
wherein in a case where a size of the inspection image is a size corresponding to a sheet whose length in a conveying direction exceeds a predetermined length, the display control unit determines the arrangement of the first display area and the second display area such that the inspection image is displayed in such a manner that a side of the inspection image parallel to the conveying direction is aligned along a horizontal direction of the confirmation screen.

13. The inspection apparatus according to claim 12,
wherein in a case where the size of the inspection image is not a size corresponding to a sheet whose length in the conveying direction exceeds the predetermined length, the display control unit determines the arrangement of the first display area and the second display area such that the inspection image is displayed in such a manner that the side of the inspection image parallel to the conveying direction is aligned along a vertical direction of the confirmation screen.

14. The inspection apparatus according to claim 11,
wherein in a case where the size of the inspection image is a size corresponding to a sheet whose length in a conveying direction exceeds a predetermined length, the display control unit determines the arrangement of the first display area and the second display area by switching, in accordance with an arrangement of the enlarged image in the confirmation screen, between displaying the inspection image in such a manner that a side of the inspection image parallel to the conveying direction is aligned along a horizontal direction of the confirmation screen and displaying the inspection image in such a manner that the side of the inspection image parallel to the conveying direction is aligned along a vertical direction of the confirmation screen.

15. The inspection apparatus according to claim 14,
wherein in a case where the size of the inspection image is a size corresponding to a sheet whose length in the conveying direction exceeds the predetermined length, if a layout has been set in which the inspection image and the enlarged image are arranged in the confirmation screen at different positions in the horizontal direction of the confirmation screen, the display control unit displays the inspection image in such a manner that the side of the inspection image parallel to the conveying direction is aligned along the vertical direction of the confirmation screen.

16. The inspection apparatus according to claim 15,
wherein in a case where the size of the inspection image is a size corresponding to a sheet whose length in the conveying direction exceeds the predetermined length, if a layout has not been set in which the inspection image and the enlarged image are arranged in the confirmation screen at different positions in the horizontal direction of the confirmation screen, the display control unit displays the inspection image in such a manner that the side of the inspection image parallel to the conveying direction is aligned along the horizontal direction of the confirmation screen.

17. The inspection apparatus according to claim 14, further comprising:
an acceptance unit configured to accept a setting of a layout of the confirmation screen,
wherein the acceptance unit is configured to accept a first layout in which the inspection image and the enlarged image are arranged in the confirmation screen at different positions in the horizontal direction of the confirmation screen, and a second layout in which the inspection image and the enlarged image are arranged in the confirmation screen at different positions in the vertical direction of the confirmation screen.

18. The inspection apparatus according to claim 17,
wherein in a case where the size of the inspection image is a size corresponding to a sheet whose length in the conveying direction exceeds the predetermined length,
if the first layout has been set, the display control unit displays the inspection image in such a manner that the side of the inspection image parallel to the conveying direction is aligned along the vertical direction of the confirmation screen, and
if the second layout has been set, the display control unit displays the inspection image in such a manner that the side of the inspection image parallel to the conveying direction is aligned along the horizontal direction of the confirmation screen.

19. The inspection apparatus according to claim 11,
wherein the display control unit displays an entirety of the inspection image in the confirmation screen in such a manner that a display size of the entirety of the inspection image is largest with the arrangement determined for the first display area and the second display area.

20. The inspection apparatus according to claim 11,
wherein the enlarged image is displayed in the confirmation screen along with an enlarged image of a corresponding area in a reference image based on which the inspection is performed.
